(19) United States
(12) Patent Application Publication
(10) Pub. No.: US 2002/0095326 A1
(43) Pub. Date: Jul. 18, 2002

(54) Automated and remotely operated vehicle dispatching, scheduling and tracking system

(75) Inventor: Barry Katz, Flushing, NY (US)

Correspondence Address: OSTROLENK FABER GERB & SOFFEN, 1180 AVENUE OF THE AMERICAS, NEW YORK, NY, 100368403

(73) Assignee: Interactive Voice Data Systems, Inc.

(21) Appl. No.: 10/045,819

(22) Filed: Jan. 10, 2002

Related U.S. Application Data
(60) Provisional application No. 60/261,966, filed on Jan. 16, 2001.

(51) Int. Cl. G06F 17/60

(52) U.S. Cl. 705/9

(57) ABSTRACT

An interactive voice response system integrated with cellular phone technology which uses wireless access protocol and/or handheld wireless Internet protocol devices to collect passenger pickup and destination addresses using nationwide database of addresses and phone numbers and to dispatch drivers to pick up passengers. The system has the capability of automatically detecting pickup location via automatic number identification and/or caller ID technology.

### RELATED CASES

This Application claims priority and is entitled to the filing date of U.S. Provisional Application Serial No. 60/261,966 filed Jan. 16, 2001 and entitled “DISPATCHER—A REMOTE SCHEDULING AND VEHICLE TRACKING SYSTEM” the contents of the provisional patent application are incorporated by reference herein.

### BACKGROUND OF THE INVENTION

The present invention relates to transportation generally and, more particularly, to a system and method that substantially automates vehicle dispatching to customers.

Corporate Limousine services use an intense manual process in collecting passenger information and then dispatching drivers to pick up passengers. The lack of an automated system to pick up and drive passengers/goods is not only endemic to the limousine industry but is also faced by the TAXI, Ambulatory Services, School Bus Services and the Small Trucking Industries.

Currently, a passenger calls a local limousine service using an 800 number. An operator picks up the phone and asks for basic information, the company's account number, budget code, telephone number and extension of the passenger, his/her pickup and destination address. After collecting the data a dispatcher provides a car number and pickup time for the passenger.

The conventional manual process of dispatching vehicles to customers and the features and services that it provides to customers are antiquated and cumbersome in the world of modern technology.

### SUMMARY OF THE INVENTION

Accordingly, it is an object of the present invention to provide an automated and remotely operable vehicle dispatching, scheduling and tracking system.

It is a further object of the invention to provide a method and system for dispatching and scheduling vehicles that is easy to use and operate.

The foregoing and other objects of the invention are realized by the system of the present invention which uses an interactive voice response system and/or automated data entry system to arrange for passenger pickup in a manner which requires reduced input from the passenger and keeps the passenger updated as to the actual versus scheduled pickup time. The system of the invention also provides a range of additional features, including a nationally based transportation arrangement, real time information, and constant updates as to the whereabouts of the vehicle that has been dispatched to the passenger site. An important aspect of the invention is based on the concept that the when the customer calls from his usual site or location, the location of the site is automatically discerned by automatic number identification or caller ID technology, which provides an electronic indicia of the calling site in the calling signal matched against a nationwide database of addresses and phone numbers thus substantially reducing the need for personnel at the dispatching station and enabling the automation thereof.

Other features and advantages of the present invention will become apparent from the following description of the invention which refers to the accompanying drawings.

### BRIEF DESCRIPTION OF THE DRAWINGS

FIG. 1 is a general block diagram of the invention.

FIG. 2 is flow chart illustrating the method of the invention involving the arranging of a passenger pickup.

FIG. 3 is a flow chart of a process that updates a passenger as to the current location of the vehicle dispatched to pick up the passenger.

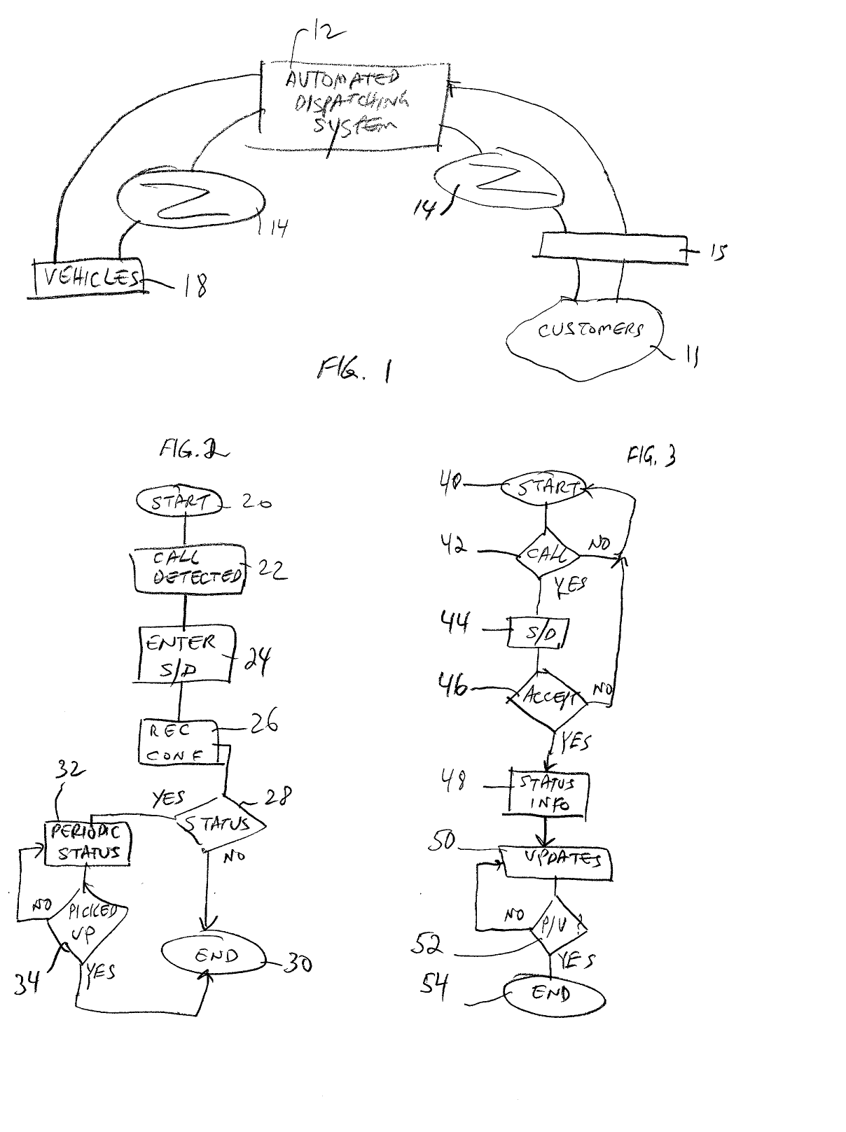

### DETAILED DESCRIPTION OF THE INVENTION

The present invention uses an interactive voice response system, integrated with cellular phone technology using Wireless Access Protocol (WAP) nationwide database of addresses and phone and handheld wireless Internet protocol devices to collect a passenger's pickup and destination addresses and to dispatch a driver to pick up the passenger. The present invention is a national automated transportation, scheduling and dispatching system that collects passenger/goods information. The system optimizes for the least costly path to pick up and deliver the passenger. It allows passengers to track the location of the vehicle, obtain real time information about the pickup and allows a passenger to cancel a scheduled vehicle ‘pickup’ anywhere within a nationally defined region. At its core, the present invention represents a system and method that substantially automates a process that heretofore has been carried out largely manually.

The system provides an automated fee calculation including tolls and provides a monthly statement for customer accounts. The system and method of the present invention is further inclusive of the optimal expedient that allows vehicles to regularly transmit their geographical positions to the automatic dispatcher by being equipped with a GPS (Global Positioning System), so that the dispatcher's system is automatically apprised of the status of each vehicle (whether occupied or available) and able to calculate their position relative to the passenger requesting pickup. In this manner, the system is able to automatically alert the specific vehicle nearest to the location to instruct that vehicle to pick up the passenger. It also enables the driver to issue appropriate wireless commands indicating whether he/she is ready and agreeable to accept a proposed passenger pickup. If the wireless signals indicate that the driver first chosen is not ready for such pickup then the system automatically searches for another vehicle, etc.

Using a Land Line or Cellular Phone

The present invention uses a voice response system. Based upon the 800 number dialed, the system detects a signal from the telephone carrier and responds with an acknowledgment. The present invention detects whether the call is ‘land line’ or from a cellular phone based upon standard carrier protocols and decides what system functions to perform and/or omit.

The present system collects DNIS and ANI protocol from the network carrier before the phone call goes off hook. DNIS enables the present invention to detect and respond to multiple limousine companies. ANI enables the present invention to detect repeat passengers. The system collects the DNIS and ANI information, parses the string and does a database look up on the string. Based upon customer and company database directories the system goes ‘off hook’. The system presents the passenger with the correct limousine vendor's greeting menu. The system collects the customer's account information, budget code and other pertinent information using either DTMF (Dual Tone Multi Frequency) or speech recognition.

If the customer is a repeat passenger, the system lists and presents the customer with the known locations for the customer and asks the passenger which of the known locations he/she wishes to go to. If it is a new passenger or an existing passenger with a new location the system requests the passenger to enter the “pickup” and “destination” phone numbers. The present invention then determines if the pickup and destination phone numbers are at an airport and confirms the particular airport required. The system then schedules a driver ‘pickup’ in one state with another driver ‘pickup’ in another state. The name of the passenger and her itinerary will be available to any driver transporting the passenger. The system has links that could provide the passenger with such options as entertainment plans, hotel reservations and accommodations, restaurant locations and local trips to museums or short excursions. Local government regulations pertaining, for example, to garbage collection, alternate side of the street parking and addresses of local municipalities are also available.

Also provided is the ability to receive advertisements from the system to display on the roof of a cab. Someone calls in or emails the latest promotional information to place on the display board of the cab. The handheld receives the data which is then sent via a USB connection to the display board.

The system tracks the car and driver inspection information for the purpose of verifying the car and driver's registration status with the local city and state requirements. This enables immediate security checks on the safeness' of the cab. The driver may get a query from the city or state agency to send his and cabs ID, or do it twice a day when he starts his shift or ends his shift. The system periodically interrogates the driver and vehicle using remote wireless handheld and WAP protocols to query the driver and car.

The customer is asked to enter their ‘pickup’ and ‘destination address’ phone numbers. The system performs a ‘database look up’, which matches the phone numbers with the ‘pickup’ and destination addresses. The system plays back the ‘pickup’ and ‘destination addresses’ and confirms the response. If the system cannot match the phone numbers the call will ‘fall through’ to a call center operator. The operator completes the addresses process and then the customer continues with the automated process. The next time a passenger calls, his/her unknown ‘pickup’ and ‘destination address’ phone number will be listed.

The system assigns an available chauffeur using a driver availability algorithm and schedule. It then transmits the customer information to the driver's hand held wireless device. The chauffeur confirms his availability and notes on his hand held wireless device his estimated time of arrival. The passenger is notified of the chauffeur's availability and estimated time of arrival while on the phone with the system.

Using Hand Held Wireless Devices

A passenger with a RIM or Palm Pilot device enters their account information followed up by their ‘pickup’ and ‘destination address’ phone number. The system performs a ‘database look up’, which matches the phone numbers with the ‘pickup’ and destination addresses. The system sends back a display with the ‘pickup’ and ‘destination addresses’ and confirms the response. If the system cannot match the phone numbers the system interrogates the passenger for additional information to complete the addresses. The system then continues with the automated process.

The system then assigns an available chauffeur using a driver availability algorithm and schedule. It then transmits the customer information to the driver's hand held wireless device. The chauffeur confirms his availability and notes on his hand held wireless device his estimated time of arrival. The passenger is notified of the chauffeur's availability and estimated time of arrival.

With reference to the drawings, the automated vehicle dispatching system 10 of the present invention comprises a computerized, automated dispatcher system 12 which communicates with customers 11, either through conventional telephone lines 13, or via the Internet 14. The customers 11 can communicate with the dispatching system 12 via their telephones designated generally by reference numeral 15 or via hand held devices 16, which may be personal digital assistants or the like. Regardless, the mere placement of a call to the automated dispatching system 12 immediately reveals to the automated dispatching system, the location of the customer, which location is transmitted either from the hand held device 16 or through the telephone equipment 15 which automatically includes ANI or caller ID information that discloses the location of the customer.

The automated dispatching system contains the appropriate tables that convert or at least provide references to the addresses, which addresses are then automatically communicated to taxis, limousines, or pickup vehicles 18, which see the address and then respond to the automated dispatch system, indicating whether they can pick up that passenger. The automated dispatch system may be aware of the locations of the vehicles 18 through their onboard equipment which incorporates GPS (Global Positioning System) equipment (not shown) that constantly indicates the vehicles' positions and which also includes with the transmission, an indication whether the vehicle is available for hire.

Based on the foregoing, the vehicle operator or the dispatcher may assign the best vehicle for the corresponding jobs.

Referring to FIG. 2, a process of the present invention includes software that starts the process at step 20 and which, upon receiving a call from a customer at step 22, automatically enters the source (pick up) and destination of the passenger 24, based on the entry of or the detection of the pickup location telephone number and/or the destination telephone or the actual destination. The system 12 then sends the customer confirmation, either through manual calling or electronically, as indicated at step 26, indicating the usual information, such as the approximate pickup time, the identity or description of the vehicle, etc.

For ease of mind, status information is provided at step 28 until the customer is actually picked up and the process completes at step 30. Otherwise, the process periodically updates the location of the vehicle at step 32 and constantly queries and transmits that information to the customer. Once the customer has been picked up, as indicated at step 34, the process ceases at step 30.

Further details of the foregoing is provided in FIG. 3, wherein the software proceeds from the start software block 40 to the block 42, which constantly monitors whether a telephone call has been received. If yes, the source/destination information is entered at step 44 and the decisional block 46 awaits the customer's acceptance of the vehicle for pickup. If the customer has so accepted the vehicle, status information is constantly sent at step 50, which is updated at step 48, which is then reupdated at step 50. This updating information continues as long as the customer has not been picked up and ceases at step 54, upon the pickup of the customer.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for dispatching vehicles for pickup and delivery, using a computerized and at least partially automated system, the method comprising the steps of:
receiving telephone messages comprising electronic indicia in a calling signal of the location of pickup sites;
receiving destination information;
contacting and identifying vehicles available for effecting pickups at various ones of the pickup sites; and
issuing instructions to vehicles to proceed to the pickup sites.

2. The dispatching system of claim 1, wherein the vehicles being dispatched are selected from a group consisting of: taxis, limousines, ambulances, school buses, and trucks.

3. The method of claim 1, comprising enabling customers at the pickup sites to interact with a central, at least partially automated, dispatching system through interactive voice communication.

4. The method of claim 1, including enabling customers to communicate with a central dispatching system which handles calls to dispatched vehicles dispersed over many different cities and comprising many different operators of vehicle fleets.

5. The method of claim 1, further including providing from the vehicles that are being dispatched, global positioning information and tracking the location of vehicles both prior to and en route to pickups.

6. The method of claim 5, further including repeated calculations of distance of the vehicle to the location of the pickup and communicating that information to the pickup location.

7. The method of the claim 6, further including calculating time of arrival at pickup sites.

8. The method of claim 7, further including calculating time of arrival based on stored traffic patterns and time of day criteria.

9. The method of claim 1, further including providing monthly statements and account information to repeat customers electronically.

10. The method of claim 1, further including using ANI and/or DNIS for determining customer locations.

11. The method of claim 1, further comprising a lookup table for customers that is indexed based on customer's telephone numbers.

12. The method of claim 1, further comprising customers communicating with a central dispatching system via voice communication with voice recognition and voice synthesis.

13. The method of claim 1, further comprising communication between customers and a central dispatching system via customer held personal digital assistants.

14. The method of claim 1, further comprising a central dispatching system communicating to customers pickup information and update information via electronic messages to customers' computers.

15. The method of claim 1, further including providing to customers ancillary data about destination sites.

16. The method of claim 15, wherein the ancillary data comprises entertainment information, accommodation information and/or transportation information.

17. The method of claim 1, further comprising enabling customers to communicate via computers that have drop down menus providing a choice of options to potential customers, including type of car, trip rate calculations and cost information.

18. The method of claim 1, further comprising providing to repeat customers a menu of a plurality of destination addresses for a customer to choose from.

19. The method of claim 1, including communicating with a central dispatching system that receives the telephone messages via the Internet.

20. The method of claim 1, including playing to customers advertising messages.
